(19) United States
(12) Patent Application Publication
(10) Pub. No.: US 2025/0171283 A1
(43) Pub. Date: May 29, 2025

(54) JACK DEVICE

(71) Applicant: Nanjing Chervon Industry Co., Ltd., Nanjing (CN)

(72) Inventors: Ziyang Chen, Nanjing (CN); Yonghui Cheng, Nanjing (CN); Pan Lin, Nanjing (CN); Ruihuang Bi, Nanjing (CN); Shubin Tong, Nanjing (CN)

(21) Appl. No.: 18/936,305

(22) Filed: Nov. 4, 2024

(30) Foreign Application Priority Data
Nov. 23, 2023 (CN) 202311582058.7

(51) Int. Cl. B66F 5/04

(52) U.S. Cl. CPC B66F 5/04

(57) ABSTRACT

A jack device includes a frame, a lifting assembly, a hydraulic assembly, a power unit, and a battery pack coupling portion. The lifting assembly is pivotally connected to the frame, one end of the lifting assembly includes a lifting pad liftable or lowerable, and the lifting pad provides an upward lifting force for a lifted object. The hydraulic assembly is configured to drive the lifting assembly to perform a lifting action or a lowering action. The power unit includes an electric motor, a reduction mechanism, and an actuator, where the reduction mechanism is disposed between the electric motor and the actuator, and the actuator is able to drive the hydraulic assembly to operate. The battery pack coupling portion is used for mounting a battery pack, where the battery pack supplies power to at least the power unit.

### RELATED APPLICATION INFORMATION

This application claims the benefit under 35 U.S.C. § 119(a) of Chinese Patent Application No. 202311582058.7, filed on Nov. 23, 2023, which application is incorporated herein by reference in its entirety.

### TECHNICAL FIELD

The present application relates to a power tool and, in particular, to a jack device.

### BACKGROUND

One type of jack device in the related art implements lifting and lowering through a manual operation of a rocker and with a high labor intensity. Another type of jack device in the related art implements lifting and lowering through a lead screw mechanism driven by an electric motor so that the working efficiency is improved. One type of jack device in the related art needs to be connected to an alternating current (AC) power supply, which limits the movement or outdoor use of the jack device.

This part provides background information related to the present application. The background information is not necessarily the existing art.

### SUMMARY

A jack device includes a frame; a lifting assembly pivotally connected to the frame, where one end of the lifting assembly includes a lifting pad liftable or lowerable, and the lifting pad provides an upward lifting force for a lifted object; a hydraulic assembly configured to drive the lifting assembly to perform a lifting action or a lowering action; a power unit including an electric motor, a reduction mechanism, and an actuator, where the reduction mechanism is disposed between the electric motor and the actuator, and the actuator is able to drive the hydraulic assembly to operate; and a battery pack coupling portion for mounting a battery pack, where the battery pack supplies power to at least the power unit.

In some examples, the battery pack is detachably connected to the jack device.

In some examples, the battery pack is inserted and removed along a direction of a first straight line, and the first straight line basically extends along a front and rear direction.

In some examples, the frame includes a base and a housing, the hydraulic assembly is disposed on the base, and the housing covers the hydraulic assembly.

In some examples, the battery pack is mounted in the housing.

In some examples, the battery pack partially protrudes out of the housing.

In some examples, when the battery pack is mounted to the battery pack coupling portion, a waterproof cover is provided on the outer side of the battery pack, and the waterproof cover covers at least the top of the battery pack.

In some examples, the lifting assembly includes a lifting arm, the frame includes a connecting portion, one end of the lifting arm is pivotally connected to the connecting portion, and the battery pack and the lifting pad are distributed on two sides of the connecting portion.

In some examples, the jack device includes at least a first operating member configured to control the hydraulic assembly to drive an action of the lifting assembly.

In some examples, the first operating member is electronically controlled.

In some examples, the jack device includes a load detection component configured to detect a load parameter of the lifting assembly, and the hydraulic assembly adjusts a lifting or lowering speed of the lifting assembly according to the load parameter.

In some examples, the jack device includes at least a second operating member configured to control the hydraulic assembly to relieve pressure.

In some examples, the jack device includes a lowering operating member configured to, in a triggered state, control the hydraulic assembly to relieve pressure, and when the lowering operating member is triggered, the lifting pad automatically descends in height.

In some examples, the hydraulic assembly includes a solenoid valve configured to open or close a pressure relief oil loop of the hydraulic assembly, and the solenoid valve is in an energized state when the lowering operating member is in the triggered state.

In some examples, the hydraulic assembly includes a hydraulic pump and a hydraulic cylinder, the actuator drives the hydraulic pump to operate, the battery pack is configured to supply power to the electric motor, a motor shaft of the electric motor extends along a direction of a second straight line, and the hydraulic cylinder acts along a direction of a third straight line, where the second straight line is parallel or perpendicular to the third straight line.

In some examples, the jack device further includes a light-emitting element disposed on the frame and configured to indicate a working state of the jack device.

In some examples, the jack device further includes a light-emitting element able to turn on or off and configured to indicate a working state of the jack device.

In some examples, the jack device further includes a light-emitting element able to be ejected or hidden and configured to indicate a working state of the jack device.

In some examples, the jack device is provided with a power interface for connecting an onboard discharge interface, and the onboard discharge interface is able to receive an onboard direct current (DC) power supply or an onboard AC power supply.

In some examples, the jack device further includes light-emitting elements for lighting and traveling wheels, the traveling wheels include front wheels and rear wheels, the front wheels are disposed on a side closer to the lifting pad, the rear wheels are disposed on the other side opposite to the front wheels, and the light-emitting elements are disposed above the rear wheels.

A floor jack device includes a frame; a lifting assembly pivotally connected to the frame, where one end of the lifting assembly includes a lifting pad liftable or lowerable, and the lifting pad provides an upward lifting force for a lifted object; a drive assembly including an electric motor and configured to drive the lifting assembly to move; a battery pack coupling portion for mounting a battery pack; a remote control device able to control at least the start and stop of the electric motor and remotely control the operation of the floor jack device; and a function key able to control at least the lifting assembly to rise or descend.

In some examples, two function keys are provided, one function key is used for controlling the lifting assembly to perform a lifting action, and the other function key is used for controlling the lifting assembly to perform a lowering action.

In some examples, three function keys are provided, a first function key is used for controlling the lifting assembly to perform a whole machine power-on action, a second function key is used for controlling the lifting assembly to perform a lifting action, and a third function key is used for controlling the lifting assembly to perform a lowering action.

In some examples, three function keys are provided, a first function key is used for controlling the lifting assembly to perform a fast lifting action, a second function key is used for controlling the lifting assembly to perform a slow lifting action, and a third function key is used for controlling the lifting assembly to perform a lowering action.

In some examples, three function keys are provided, a first function key is used for controlling the lifting assembly to perform a lifting action, a second function key is used for controlling the lifting assembly to perform a pause action, and a third function key is used for controlling the lifting assembly to perform a lowering action.

In some examples, four function keys are provided, a first function key is used for controlling the lifting assembly to perform a fast lifting action, a second function key is used for controlling the lifting assembly to perform a slow lifting action, a third function key is used for controlling the lifting assembly to perform a pause action, and a fourth function key is used for controlling the lifting assembly to perform a lowering action.

In some examples, the lifting pad has a first lifting speed before being in contact with the lifted object and has a second lifting speed after being in contact with the lifted object, where the first lifting speed is greater than the second lifting speed.

In some examples, a rotational speed curve is preset, and after the lifting pad is in contact with the lifted object, the second lifting speed changes according to the rotational speed curve.

In some examples, a constant target speed is preset, and after the lifting pad is in contact with the lifted object, the second lifting speed is the target speed.

In some examples, the jack device includes a load detection component configured to detect a load parameter of the lifting assembly, and the drive assembly adjusts a lifting or lowering speed of the lifting assembly according to the load parameter.

In some examples, the drive assembly includes a hydraulic assembly, the hydraulic assembly includes a solenoid valve configured to open or close a pressure relief oil loop of the hydraulic assembly, the pressure relief oil loop includes one or more manual switches, and if the solenoid valve is powered off, the manual switches are operable to implement pressure relief.

In some examples, when the lifting assembly is in a lifting state or a lowering state, a trigger of any function key enables the lifting assembly to suspend movement.

In some examples, the jack device further includes a light-emitting element disposed on the frame and configured to indicate a working state of the jack device.

In some examples, the jack device further includes a light-emitting element able to turn on or off and configured to indicate a working state of the jack device.

In some examples, the jack device further includes a light-emitting element able to be ejected or hidden and configured to indicate a working state of the jack device.

### BRIEF DESCRIPTION OF THE DRAWINGS

FIG. 1 is a structural view of a jack device in a lifting state according to the present application.

FIG. 2 is a structural view one of a jack device in a stored state according to the present application.

FIG. 3 is a front view of a jack device in a lifting state according to the present application.

FIG. 4 is a front view of a jack device in a stored state according to the present application.

FIG. 5 is a structural view one of part of the structure of a jack device according to the present application.

FIG. 6 is a top view of part of the structure of a jack device according to the present application.

FIG. 7 is a structural view two of a jack device in a stored state according to the present application.

FIG. 8 is a structural view three of a jack device in a stored state according to the present application.

FIG. 9 is a structural view four of a jack device in a stored state according to the present application.

FIG. 10 is a structural view five of a jack device in a stored state according to the present application.

FIG. 11 is an exploded view one of a jack device according to the present application.

FIG. 12 is an exploded view two of a jack device according to the present application.

FIG. 13 is a structural view two of part of the structure of a jack device according to the present application.

FIG. 14 is a structural view three of part of the structure of a jack device according to the present application.

FIG. 15 is a front view of part of the structure of a jack device according to the present application.

FIG. 16 is a structural view of an electric motor, a reduction mechanism, and an actuator of a jack device according to the present application.

FIG. 17 is a principle diagram one of a hydraulic assembly of a jack device according to the present application.

FIG. 18 is a principle diagram two of a hydraulic assembly of a jack device according to the present application.

FIG. 19 is a schematic diagram of a solenoid valve and a pressure relief pipe of a jack device according to the present application.

FIG. 20 is a structural view of the solenoid valve of FIG. 19.

FIG. 21 is a structural view of a light-emitting element of a jack device according to the present application.

FIG. 22 is a structural view of another light-emitting element of a jack device according to the present application.

FIG. 23 is a schematic diagram of connections between a jack device and onboard power supplies according to the present application.

FIG. 24 is a structural view of a handle assembly of a jack device according to the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

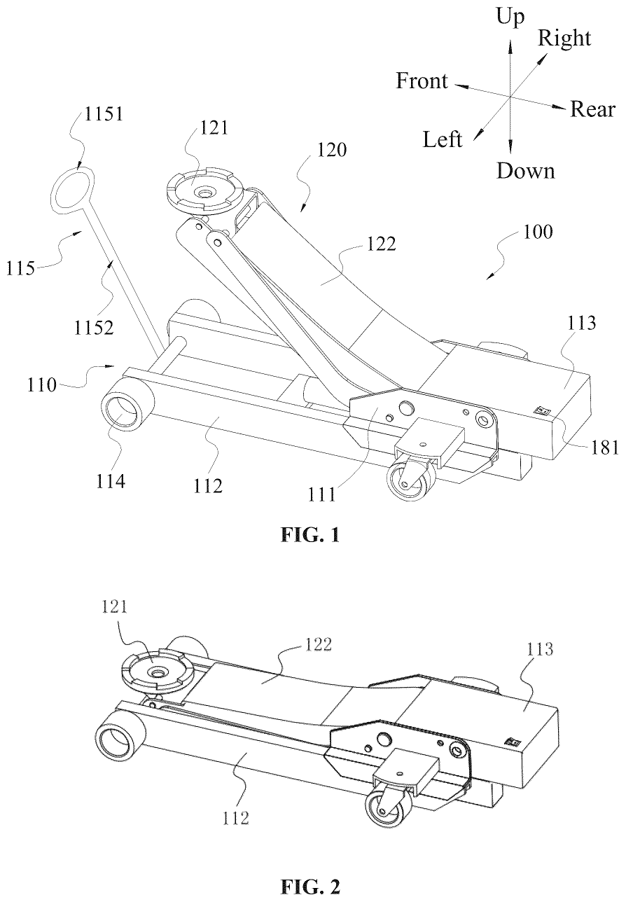

Referring to FIGS. 1 and 2, the present application provides a jack device 100 including a frame 110 and a lifting assembly 120, where the lifting assembly 120 is pivotally connected to the frame 110, one end of the lifting assembly 120 includes a lifting pad 121 liftable or lowerable, and the lifting pad 121 provides an upward lifting force for a lifted object. When the lifting assembly 120 rotates upwards, the lifting pad 121 is lifted. When the lifting assembly 120 rotates downwards, the lifting pad 121 is lowered.

A front and rear direction, a left and right direction, and an up and down direction of the jack device 100 are defined. A position at which the lifting assembly 120 pivots on the frame 110 is closer to the rear end of the jack device 100, the lifting assembly 120 rises along the up and down direction, and a pivot axis of the lifting assembly 120 is basically in the left and right direction.

The lifting assembly 120 includes a lifting arm 122, the frame 110 includes a connecting portion 111, and one end of the lifting arm 122 is pivotally connected to the connecting portion 111. One or two lifting arms 122 may be provided. When two lifting arms 122 are provided, the two lifting arms 122 are linkable to each other.

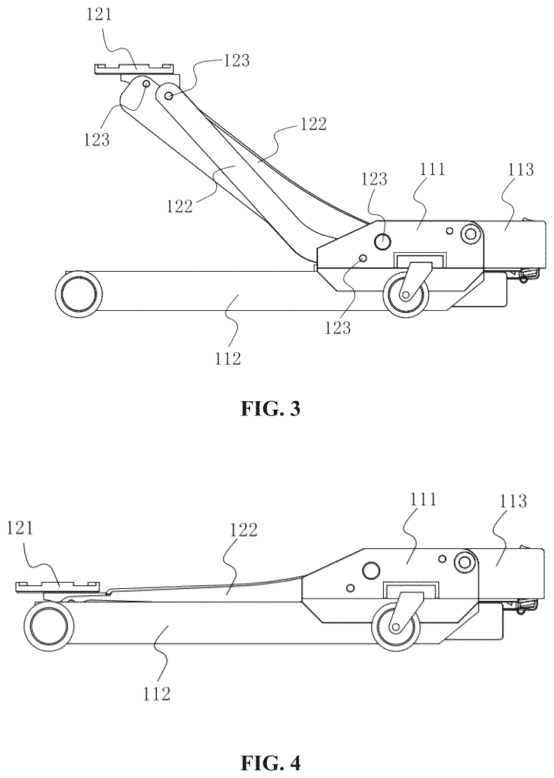

In an example, neither of the two lifting arms 122 is straight but has a certain curvature. The two lifting arms 122 are connected by four pivot shafts 123. As shown in FIG. 3, two pivot shafts 123 disposed on the frame 110 are fixed shafts to prevent overturning. When one lifting arm 122 is driven, the one lifting arm 122 actively rises and the other lifting arm 122 is passively lifted. Since the two lifting arms 122 are neither straight and have different shapes, the lifting pad 121 can always remain horizontal. Theoretically, for a floor jack device as shown in FIG. 1, as long as the two lifting arms 122 are not both straight or one of the four pivot shafts 123 is movable, the lifting pad 121 can always remain horizontal in a lifting process. Referring to FIGS. 3 and 4, the lifting assembly 120 has a lifting state and a stored state. When the lifting assembly 120 is in the stored state, the lifting assembly 120 is at a storage position. When the lifting assembly 120 is in the lifting state, the lifting assembly 120 may be locked at any position above the storage position. In the lifting process of the lifting assembly 120, the lifting pad 121 is always in a horizontal state, facilitating a relatively large contact area with the lifted object.

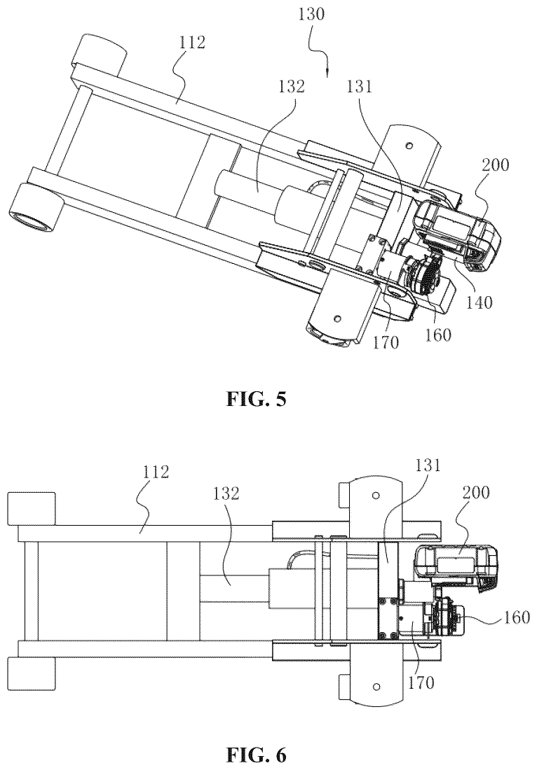

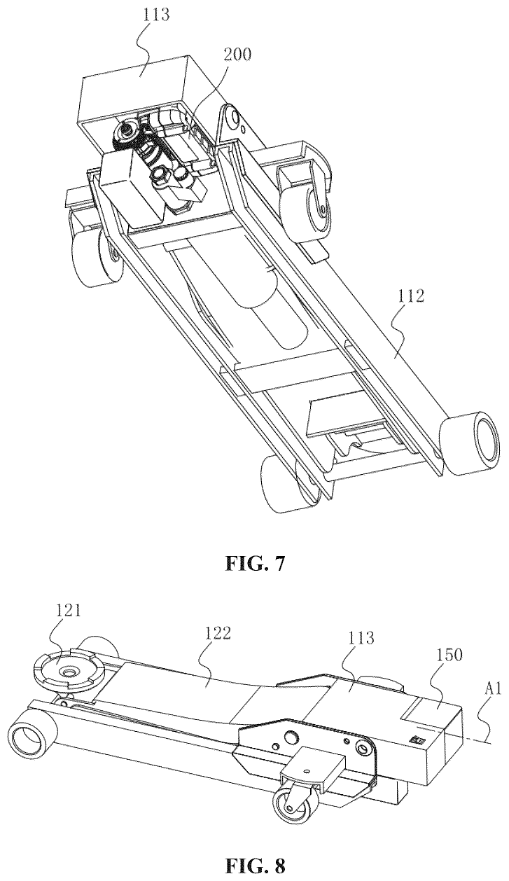

Referring to FIGS. 1, 5, and 6, the jack device 100 further includes a drive assembly, and the drive assembly includes a power unit 160 and a hydraulic assembly 130. The power unit 160 provides power for the hydraulic assembly 130. The hydraulic assembly 130 is configured to drive the lifting assembly 120 to perform a lifting action or a lowering action. The lifting assembly 120 is driven by the hydraulic assembly 130, thereby improving stability. The hydraulic assembly 130 includes a hydraulic pump 131 and a hydraulic cylinder 132. The hydraulic cylinder 132 acts along a direction of a straight line. When pressure in the hydraulic cylinder 132 is increased, the lifting assembly 120 performs the lifting action. When the pressure in the hydraulic cylinder 132 is decreased, the lifting assembly 120 performs the lowering action. When the pressure in the hydraulic cylinder 132 is maintained, the lifting assembly 120 remains at a current position. In an example, the hydraulic pump 131 is a plunger pump.

The jack device 100 further includes a battery pack coupling portion 140 for mounting a battery pack 200, and the battery pack 200 supplies power to at least the power unit 160 that can drive the hydraulic assembly 130 to move. The battery pack 200 provides an energy source for the operation of the hydraulic assembly 130, and the hydraulic assembly 130 drives the lifting assembly 120 to perform the lifting action or the lowering action, thereby reducing labor intensity and making the operation more labor-saving. The battery pack 200 supplies power so that a power supply circuit is simplified, a fault rate is reduced, and relatively good recyclability is achieved.

The battery pack 200 is detachably connected to the jack device 100, facilitating charging, replacement, and maintenance. In some examples, the battery pack 200 is detachably connected to the frame 110. The battery pack 200 does not need to be lifted or lowered along with the lifting assembly 120, facilitating the layout of wires. In some examples, the battery pack 200 is detachably connected to the lifting assembly 120. In some examples, the battery pack 200 is detachably connected to the hydraulic assembly 130.

The battery pack coupling portion 140 can match battery packs 200 of different specifications to adapt to different requirements. In some examples, the jack device 100 has a dual-pack or multi-pack battery compartment that can accommodate two battery packs 200 or more than two battery packs 200. The battery pack 200 may be a lithium battery pack, a solid-state battery pack, or a pouch battery pack. In some examples, the rated voltage of the battery pack 200 is greater than or equal to 10 V and less than or equal to 36 V. Such battery packs 200 have a relatively small rated voltage. In some examples, the rated voltage of the battery pack 200 is 10.8 V, 12 V, 16 V, 20 V, 24 V, 30 V, or 36 V. The battery pack 200 includes a battery pack housing and a cell group. The battery pack housing is assembled to form an accommodation space for fixing and accommodating the cell group. The cell group includes multiple cells for storing energy, where the multiple cells are connected in series, in parallel, or both in series and in parallel to form the cell group. The battery pack 200 further includes a battery pack positive terminal and a battery pack negative terminal electrically connected to an external circuit.

In some examples, the capacity of the battery pack 200 is greater than or equal to 1 Ah and less than or equal to 12 Ah. In an example, the battery pack 200 has a rated voltage of 18 V and a capacity of 1.5 Ah. In an example, the battery pack 200 has a rated voltage of 24 V and a capacity of 8 Ah. With such a setting, considering different working conditions under which the jack device 100 is used at home or in a repair shop, it can be ensured that the jack device 100 mounted with a fully charged battery pack 200 can work for at least about 8 h.

In examples of the present application, the battery pack 200, as an energy storage device, can store electrical energy to power the jack device or power other electrical equipment that needs electrical energy. The electrical equipment may be any equipment that needs electricity as an energy source. In an example, the electrical equipment includes handheld power tools such as an electric drill, an angle grinder, a sander, a chain saw, and a blower. In an example, the electrical equipment may also be a lamp, a mosquito repellent device, a fan, a cellphone, a computer, and other electrical equipment for daily use. In an example, the electrical equipment may also include transportation equipment such as a vehicle and a stand-up scooter.

In some examples, the battery pack 200 and the lifting pad 121 are distributed on two sides of the connecting portion 111. Space is fully utilized, the weight is reasonably distributed, and the balance of the jack device 100 is ensured.

The battery pack 200 may be hidden to prevent the battery pack 200 from being damaged by an external environment. The battery pack 200 may be exposed, facilitating mounting and removal. The battery pack 200 may be partially hidden and partially exposed.

Referring to FIGS. 1, 7, and 8, the frame 110 includes a base 112 and a housing 113, the hydraulic assembly 130 is disposed on the base 112, and the housing 113 covers the hydraulic assembly 130. The housing 113 protects the hydraulic assembly 130. The lifting assembly 120 is pivotally connected to the base 112. The housing 113 and the lifting pad 121 are distributed on the two sides of the connecting portion 111, the housing 113 is used for covering part of the hydraulic assembly 130, and part of the hydraulic assembly 130 is disposed below the lifting assembly 120. When the lifting assembly 120 is at the storage position, the lifting assembly 120 shields the hydraulic assembly 130.

Multiple traveling wheels 114 are disposed on the base 112 to conveniently drive the frame 110 to travel. At least two traveling wheels 114 are provided. In some examples, the multiple traveling wheels 114 are distributed on the left and right sides of the base 112.

In some examples, the battery pack 200 is mounted in the housing 113. The housing 113 protects the battery pack 200. In some examples, the battery pack 200 partially protrudes out of the housing 113.

The shape of the housing 113 may be set according to actual needs, which may be a rectangular parallelepiped, a cylinder, or other shapes. With reference to the front and rear direction, the left and right direction, and the up and down direction of the jack device 100, the housing 113 has a front side, a rear side, a left side, a right side, an upper side, and a lower side. When the battery pack 200 protrudes out of the housing 113, the battery pack 200 may protrude from any one side, any two sides, or any three sides of the housing 113 where implementable.

During assembly, the battery pack 200 may be mounted before the housing 113, or the housing 113 may be mounted before the battery pack 200. In some examples, when the battery pack 200 is mounted to the battery pack coupling portion 140, a waterproof cover 150 is provided on the outer side of the battery pack 200, and the waterproof cover 150 covers at least the top of the battery pack 200 to protect the battery pack 200.

In some examples, the battery pack 200 is disposed at a corner of the housing 113.

Referring to FIGS. 8 to 12, the battery pack 200 is disposed on the battery pack coupling portion 140 in an insertable and removable manner, and a direction along which the battery pack 200 is inserted and removed may be set according to actual needs. The direction along which the battery pack 200 is inserted and removed may be the front and rear direction, the left and right direction, or the up and down direction or may form an angle with any direction.

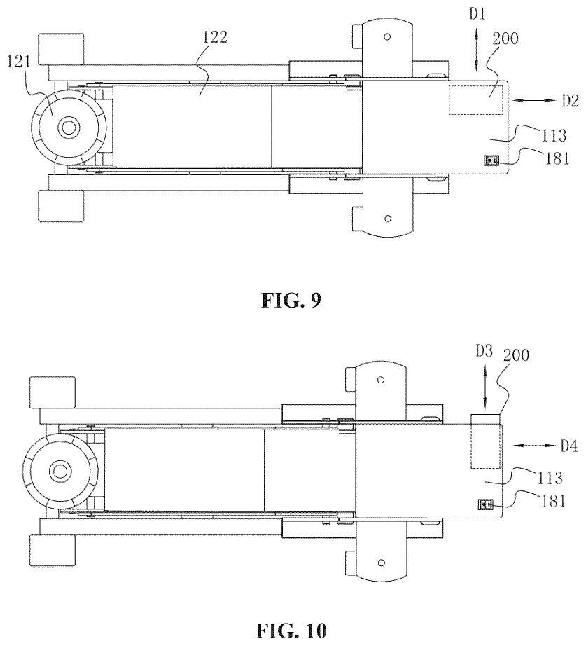

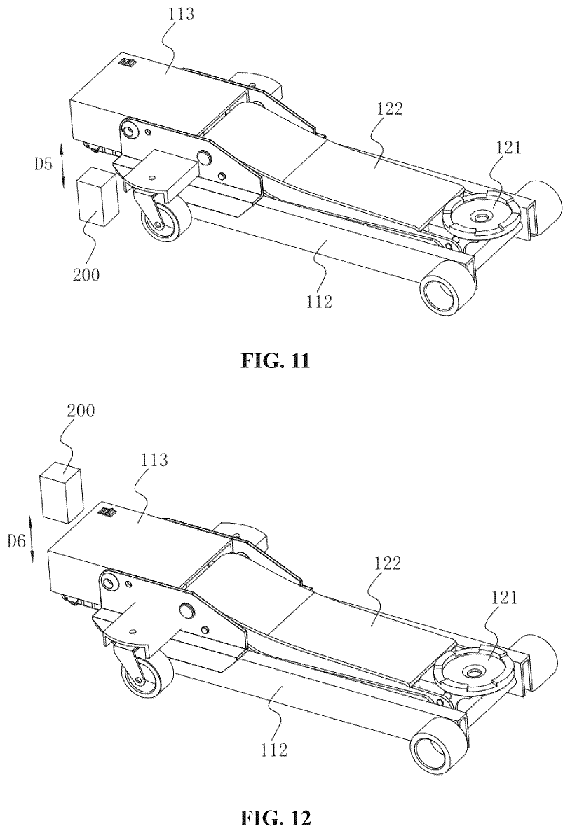

In some examples, the battery pack 200 is inserted and removed along a direction of a first straight line A1, and the first straight line A1 basically extends along the front and rear direction. Referring to FIG. 9, the battery pack 200 is hidden in the housing 113, and the battery pack 200 is inserted and removed along a direction D1 or D2. Referring to FIG. 10, an end of the battery pack 200 protrudes from the right side of the housing 113, and the battery pack 200 is inserted and removed along a direction D3 or D4. Referring to FIG. 11, the battery pack 200 is hidden in the housing 113, and the battery pack 200 is inserted and removed along a direction D5. Referring to FIG. 12, an end of the battery pack 200 protrudes from the top of the housing 113, and the battery pack 200 is inserted and removed along a direction D6.

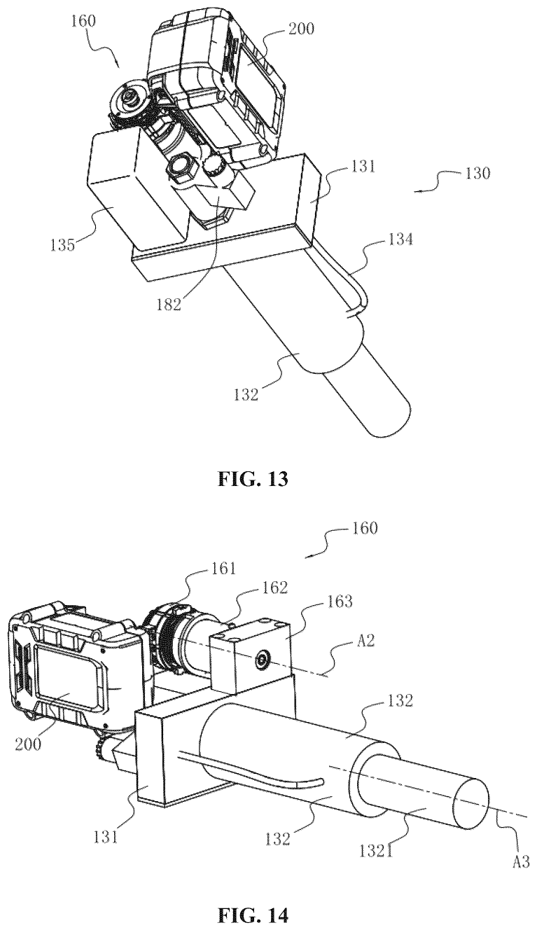

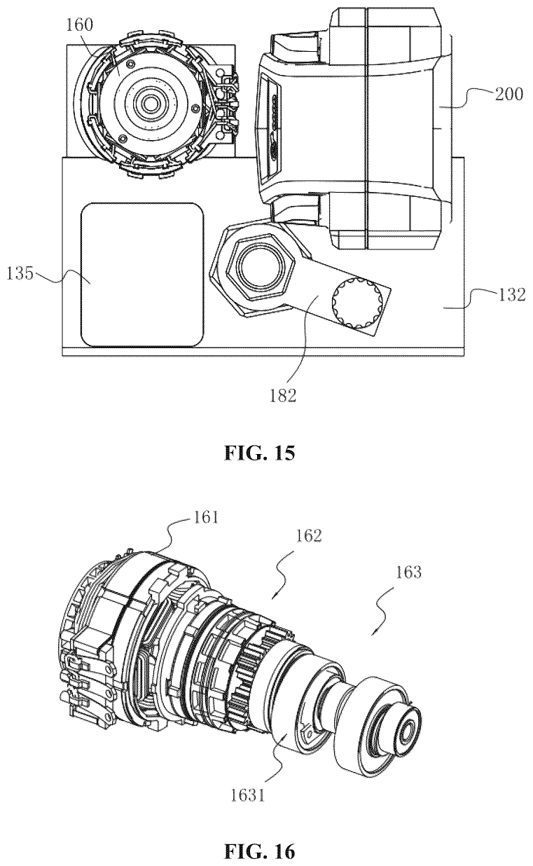

Referring to FIGS. 13 to 15, the jack device 100 further includes the power unit 160, the power unit 160 includes an electric motor 161, a reduction mechanism 162, and an actuator 163. The electric motor 161 drives the actuator to move, and the actuator 163 can drive the hydraulic assembly 130 to operate. The reduction mechanism 162 connects the electric motor 161 and the actuator 163, reduces a speed of rotation output from the electric motor 161 and transfers a movement to the actuator 163. In one embodiment, the reduction mechanism 162 is disposed between the electric motor 161 and the actuator 163.

In some examples, the actuator 163 drives the hydraulic pump 131 to operate, the battery pack 200 is configured to supply power to the electric motor 161, a motor shaft of the electric motor 161 extends along a direction of a second straight line A2, and the hydraulic cylinder 132 acts along a direction of a third straight line A3, where the second straight line A2 is parallel or perpendicular to the third straight line A3, facilitating layout. The hydraulic pump 131 is connected to the hydraulic cylinder 132 by an oil pipe 134.

In some examples, the reduction mechanism 162 includes a gearbox. The gearbox includes a box and a transmission mechanism, the transmission mechanism includes an input shaft and an output shaft, the input shaft is connected to the motor shaft of the electric motor 161, and the output shaft is connected to the hydraulic pump. In some examples, the input shaft is coaxial with the output shaft to reduce occupied space. A planetary gearset may be disposed between the input shaft and the output shaft.

Referring to FIG. 16, the actuator 163 includes an output shaft and a cam 1631 disposed on the output shaft. The electric motor 161 drives, through the reduction mechanism 162, the output shaft to rotate to drive the cam 1631 to rotate.

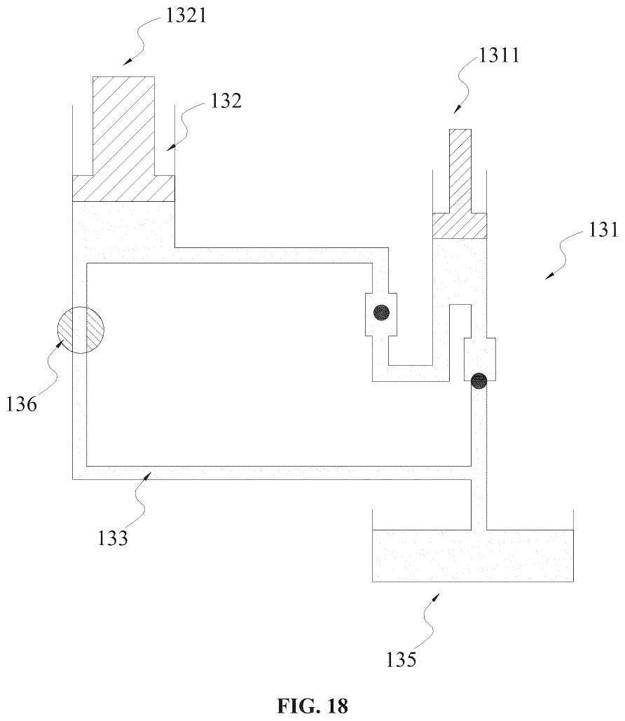

Referring to FIGS. 13 to 18, the hydraulic pump 131 has a power input end 1311, the cam 1631 acts on the power input end 1311, the hydraulic cylinder 132 has a power output end 1321, and the power output end 1321 acts on the lifting assembly 120. When the cam 1631 acts on the power input end 1311, a plunger of the hydraulic pump 131 applies pressure to hydraulic oil, a check valve between the hydraulic pump 131 and an oil can 135 is closed, a check valve between the hydraulic pump 131 and the hydraulic cylinder 132 is opened, and the hydraulic oil enters the hydraulic cylinder 132 so that the power output end 1321 of the hydraulic cylinder 132 extends, the power output end 1321 acts on the lifting assembly 120, and the lifting assembly 120 rises.

When the hydraulic pump 131 stops increasing the pressure in the hydraulic cylinder 132, the lifting assembly 120 remains in the lifting state. The hydraulic pump 131 and the hydraulic cylinder 132 is connected with a pressure relief oil loop 133 to release pressure of the oil. When a relief valve 136 on the pressure relief oil loop 133 is opened, the check valve between the hydraulic pump 131 and the hydraulic cylinder 132 is closed, and the hydraulic oil in the hydraulic cylinder 132 flows back to the oil can 135 so that the power output end 1321 of the hydraulic cylinder 132 retracts, a lifting force applied by the power output end 1321 to the lifting assembly 120 is reduced, and the lifting assembly descends.

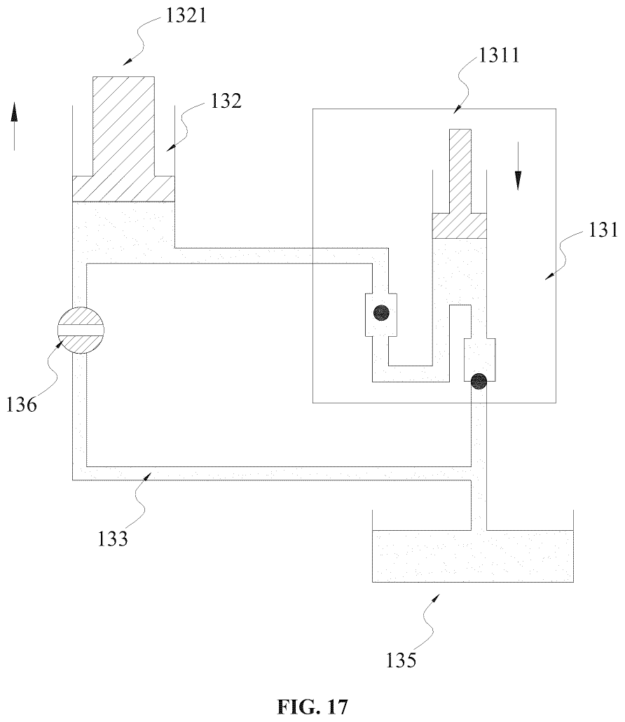

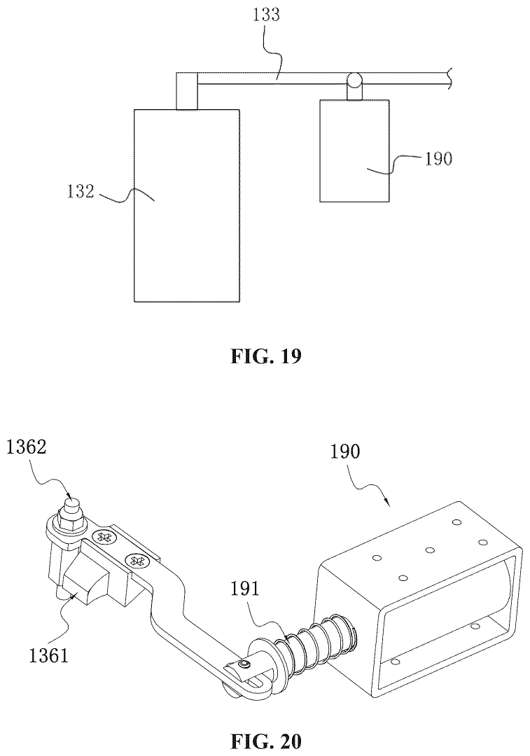

Referring to FIGS. 17 to 20, the hydraulic assembly 130 includes a solenoid valve 190 configured to open or close the pressure relief oil loop 133 of the hydraulic assembly 130, and the solenoid valve 190 is in an energized state when a lowering operating member is in a triggered state. A state of the solenoid valve 190 is controlled by the lowering operating member. When the solenoid valve 190 is energized, the pressure is relieved. When the solenoid valve 190 is de-energized, the pressure is maintained. The de-energization of the solenoid valve 190 includes no power supply or an abnormal power-off of the solenoid valve 190. When the solenoid valve 190 is de-energized, the jack device 100 cannot descend and the relief valve 136 is in a normally closed state.

The reason why the solenoid valve 190 can open or close the pressure relief oil loop 133 of the hydraulic assembly 130 is that the solenoid valve 190 is connected to the relief valve 136 on the pressure relief oil loop 133. The relief valve 136 includes a relief valve core 1361 and a relief shaft 1362, and the relief valve core 1361 can rotate around the relief shaft 1362. A solenoid valve core 191 of the solenoid valve 190 is connected to the relief valve core 1361 of the relief valve 136. When energized, the solenoid valve core 191 can act along a first direction to drive the relief valve core 1361 to act so that the relief valve 136 is opened.

The action direction of the solenoid valve core 191 of the solenoid valve 190 is referred to as a valve pulling direction, and the valve pulling direction of the solenoid valve 190 forms an angle with an axis of the pressure relief oil loop 133. In some examples, the valve pulling direction of the solenoid valve 190 is perpendicular to the axis of the pressure relief oil loop 133.

The pressure relief oil loop 133 controlled by the solenoid valve 190 includes one or more manual switches. If the solenoid valve 190 is powered off, the manual switches are operable to implement pressure relief Specifically, a user may implement the pressure relief through a manual switch so that the jack device 100 descends. In some examples, the manual switch has an automatic reset function, and a reset position is a normally closed position of the pressure relief oil loop 133. The manual switch is operated so that an action is manually and directly performed on the relief valve 136 or an action is manually performed on a button or knob of the relief valve 136, thereby implementing backflow and pressure relief.

Referring to FIGS. 1 and 9, the jack device 100 includes at least a first operating member 181 configured to control the hydraulic assembly 130 to drive an action of the lifting assembly 120. The action of the lifting assembly 120 includes the lifting action, the lowering action, and a pause action. In an example, the lifting action is divided into a fast lifting action and a slow lifting action and the lowering action is divided into a fast lowering action and a slow lowering action.

The first operating member 181 may be a mechanical member or an electronic control. The preceding actions may be implemented by using the number of first operating members 181 and a state of the first operating member 181. In some examples, the first operating member 181 is electronically controlled. Specifically, the first operating member may be a press key, a toggle key, or a push key. The first operating member 181 implements a function of a switch by controlling the action of the lifting assembly 120. The first operating member may be a stepless speed regulation switch (trigger switch) or a triggerable switch (a touch switch, a microswitch, or a button switch).

In some examples, the first operating member 181 includes a function key, and the function key can control at least the lifting assembly 120 to rise or descend.

In some examples, different function keys are pressed so that the corresponding actions are performed. When an up function key is pressed, the electric motor 161 starts and drives the hydraulic assembly 130 so that the jack device 100 completes the lifting action. When a down function key is pressed, an electronic control (such as the solenoid valve) controls the hydraulic assembly 130 to relieve the pressure so that the jack device 100 completes the lowering action. When a pause function key is pressed, the jack device 100 suspends the action.

In some examples, the first operating member 181 includes two function keys, one function key is used for controlling the lifting assembly 120 to perform the lifting action, and the other function key is used for controlling the lifting assembly 120 to perform the lowering action. At most one of the two function keys is in the triggered state.

In some examples, the first operating member 181 includes three function keys, a first function key is used for controlling the lifting assembly 120 to perform a whole machine power-on action, a second function key is used for controlling the lifting assembly 120 to perform the lifting action, and a third function key is used for controlling the lifting assembly 120 to perform the lowering action.

In some examples, the first operating member 181 includes three function keys, the first function key is used for controlling the lifting assembly 120 to perform the fast lifting action, the second function key is used for controlling the lifting assembly 120 to perform the slow lifting action, and the third function key is used for controlling the lifting assembly 120 to perform the lowering action. At most one of the three function keys is in the triggered state.

In some examples, the first operating member 181 includes three function keys, the first function key is used for controlling the lifting assembly 120 to perform the lifting action, the second function key is used for controlling the lifting assembly 120 to perform the pause action, and the third function key is used for controlling the lifting assembly 120 to perform the lowering action. At most one of the three function keys is in the triggered state.

In some examples, the first operating member 181 includes four function keys, the first function key is used for controlling the lifting assembly 120 to perform the fast lifting action, the second function key is used for controlling the lifting assembly 120 to perform the slow lifting action, the third function key is used for controlling the lifting assembly 120 to perform the pause action, and a fourth function key is used for controlling the lifting assembly 120 to perform the lowering action. At most one of the four function keys is in the triggered state.

In some examples, a fast lift and a slow lift may each be performed at a constant speed. In some examples, a lifting speed may be variable.

The lifting action of the lifting assembly 120 may be divided into a first lifting stage and a second lifting stage. The first lifting stage is a process from when the lifting pad 121 is not in contact with the lifted object to when the lifting pad 121 is in contact with the lifted object. The second lifting stage is a process from when the lifting pad 121 is in contact with the lifted object to when the lifting pad 121 lifts the lifted object to a certain height. In the first lifting stage, a first lifting speed is used. In the second lifting stage, a second lifting speed is used. The lifting speed here refers to a speed at which the lifting pad 121 moves in a movement direction. In this example, the lifting speed is a speed at which the lifting pad 121 moves along the up and down direction.

In an example, the first lifting speed is greater than the second lifting speed. With such a setting, a time it takes for the jack device 100 to touch the lifted object is reduced, thereby improving the lifting efficiency.

In some examples, the jack device 100 includes a load detection component configured to detect a load parameter of the lifting assembly 120, and the hydraulic assembly 130 adjusts a lifting or lowering speed of the lifting assembly 120 according to the load parameter. The larger the load, the smaller the lifting or lowering speed. The smaller the load, the greater the lifting or lowering speed. The load parameter may be a working current of the electric motor 161, and a size of the load is determined according to the working current. When the working current is lower than a first threshold, no load is determined and the lifting assembly 120 may rise fast. When the working current is higher than a second threshold, a relatively large load is determined and the lifting speed of the lifting assembly 120 is reduced. The lifting speed of the lifting assembly 120 may be reduced in gears according to a difference between the current working current and the first threshold. The load parameter may be a magnitude of a vertical downward external force exerted on the lifting pad 121 or may be a magnitude of hydraulic pressure provided by the hydraulic assembly 130.

In an example, a rotational speed curve is preset. After the lifting pad 121 is in contact with the lifted object, the second lifting speed changes according to the rotational speed curve. That is, when the jack device 100 is in a loaded state and the jack device 100 lifts the lifted object upwards, the second lifting speed is controlled at a preset speed so that the jack device 100 can achieve maximum lifting efficiency.

In an example, a constant target speed is preset. After the lifting pad 121 is in contact with the lifted object, the second lifting speed is the target speed. That is, when the jack device 100 is in the loaded state, the second lifting speed is controlled at a preset speed so that the jack device 100 can achieve the maximum lifting efficiency.

The lifting assembly 120 has the storage position and a lifting limit position. In the lifting process, when the lifting assembly 120 moves to the lifting limit position, the lifting assembly 120 stops lifting. In a lowering process, when the lifting assembly 120 moves to the storage position, the lifting assembly 120 stops descending.

The pressure relief of the hydraulic assembly 130 may be performed manually or electronically. The hydraulic assembly 130 includes the pressure relief oil loop 133 having a pressure relief opening at which the relief valve 136 is disposed. The pressure relief principle is that the relief valve 136 is opened so that oil in the pressure relief oil loop 133 flows back into the oil can 135.

Referring to FIGS. 13 to 15, the jack device 100 includes at least a second operating member 182 configured to control the hydraulic assembly 130 to relieve the pressure. The second operating member 182 may be mechanical or electronically controlled. In some examples, the second operating member 182 is mechanical. An action is manually and directly performed on the relief valve 136 or an action is manually performed on the button or knob of the relief valve 136, thereby implementing backflow and pressure relief. In some examples, the second operating member 182 includes a hand crank and a ball, the ball is disposed in the pressure relief oil loop 133 of the hydraulic assembly 130 and used for blocking the pressure relief oil loop 133, and the hand crank is configured to release or abut against the ball. The hand crank may be threadedly connected to the pressure relief oil loop 133. The hand crank abuts against the ball so that the ball blocks the pressure relief oil loop 133. When the hand crank is unscrewed, the ball is loosened and the oil in the pressure relief oil loop 133 may flow back so that the pressure relief is implemented and the jack device 100 descends. The oil in the pressure relief oil loop 133 may flow back into the oil can 135.

In some examples, the second operating member 182 is electronically controlled. The hydraulic assembly 130 includes the solenoid valve 190 and the relief valve 136 is connected to the solenoid valve 190. The state of the solenoid valve 190 is controlled by the second operating member 182 to open or close the relief valve 136.

In some examples, the jack device 100 includes the lowering operating member configured to, in the triggered state, control the hydraulic assembly 130 to relieve the pressure. When the lowering operating member is triggered, the lifting pad 121 automatically descends in height. The lowering operating member implements a one-key lowering function and is convenient to operate. Manual screwing is not required for pressure relief Even if the electric motor 161 stops rotating, one-key lowering can be implemented.

Electronic controls are not limited to the first operating member 181, the second operating member 182, and the lowering operating member and further include function keys such as a startup key and a shutdown key. In some examples, the electronic controls are disposed on the housing 113. In some examples, the electronic controls are disposed on a remote control device.

In some examples, the jack device 100 includes the remote control device that can control at least the start and stop of the electric motor 161. The remote control device can remotely control the operation of the jack device 100. The remote control device is connected to the jack device 100 in a wireless manner. The wireless manner includes, but is not limited to, infrared communication, Bluetooth, or wireless communication in a frequency band of 10 kHz to 2.4 GHz, such as 2.4 GHz communication. The remote control device may match a controller of the jack device 100 one to one, so as to prevent accidental control by a non-matching remote control. When the remote control device controls the operation of the controller, the distance between the controller and the remote control device is less than or equal to 5 m.

The electric motor 161 and the solenoid valve 190 are controlled so that the lifting, lowering, and pause actions of the jack device 100 are implemented. In some examples, the relief valve 136 is closed, and the electric motor 161 is controlled to operate to drive the hydraulic assembly 130 to control the lifting assembly 120 to complete the lifting action. The electric motor 161 is controlled to stop rotating, and the relief valve 136 is opened so that the lowering action is completed.

To prevent an accidental trigger of the electronic control, when the lifting assembly 120 of the jack device 100 is in a stationary state, only after a first set time since the electronic control is triggered, can the jack device 100 begin to respond. In the lifting process of the lifting assembly 120 of the jack device 100, if the electronic control with a lowering or pause function is triggered, the lifting assembly 120 stops the action immediately and does not enter a lowering mode. When the lifting assembly 120 of the jack device 100 is in motion, the jack device 100 responds immediately since the electronic control is triggered. In some examples, in the lifting process of the lifting assembly 120 of the jack device 100, if the electronic control with the pause function is triggered, the lifting assembly 120 stops the action immediately. In some examples, when the lifting assembly 120 of the jack device 100 is in the lifting state or a lowering state, a trigger of any function key enables the lifting assembly 120 of the jack device 100 to suspend movement.

The jack device 100 further includes an indication component, and the indication component indicates a working state of the jack device 100. The indication component includes a light-emitting element 170 and/or a buzzer. The light-emitting element 170 may be a light-emitting diode (LED) light. The battery pack 200 may provide electrical energy for the indication component.

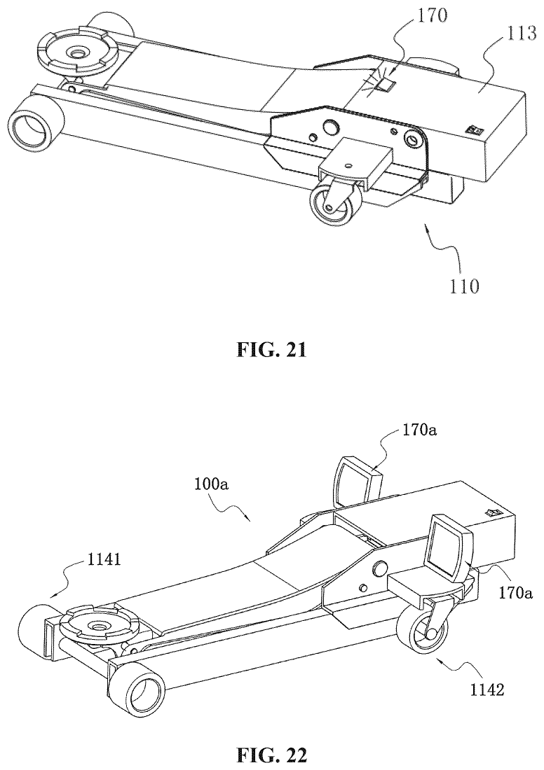

When the light-emitting element 170 is used alone for indication, the number of light-emitting elements 170 may be set as needed, and the light-emitting element 170 implements lighting and indication functions. Referring to FIG. 21, the light-emitting element 170 is disposed on the frame 110, specifically on the housing 113, and more specifically on the top surface of the housing 113, facilitating observation. In some examples, the light-emitting element 170 may be turned on or off, and a state of the light-emitting element 170 may be changed under the automatic control of a control circuit or through a manual operation. In some examples, the light-emitting element 170 can be ejected or hidden, thereby saving space and protecting the light-emitting element 170. The light-emitting element 170 may be ejected perpendicular to a surface of the housing 113 or rotated relative to the surface of the housing 113. In some examples, the light-emitting element 170 is the LED light.

In some examples, when the jack device 100 is in a normal working state, the light-emitting element 170 is always on; when the jack device 100 is in an undervoltage state, the light-emitting element 170 flickers at a first flicker frequency; when the jack device 100 is in a protected state, the light-emitting element 170 flickers at a second flicker frequency. The protected state includes overcurrent protection, overtemperature protection, and locker-rotor protection.

Different flicker frequencies may be set according to different protected states.

When the buzzer is used alone for indication, the number of buzzers may be set as needed, and the buzzer is controlled at different sounding frequencies and different volumes to indicate different states. In some examples, when the jack device 100 is in the normal working state, the buzzer produces no sound; when the jack device 100 is in the undervoltage state, the buzzer sounds at a first sounding frequency and a first volume; when the jack device 100 is in the protected state, the buzzer sounds at a second sounding frequency and a second volume. The protected state includes the overcurrent protection, the overtemperature protection, and the locker-rotor protection. Different sounding frequencies and volumes may be set according to different protected states.

When both the light-emitting element 170 and the buzzer are disposed, the number of light-emitting elements 170 and the number of buzzers may be set as needed, the light-emitting element 170 implements the lighting function, and the light-emitting element 170 and the buzzer mate to implement the indication function. In some examples, when the jack device 100 is in the normal working state, the light-emitting element 170 is always on and the buzzer produces no sound; when the jack device 100 is in the undervoltage state, the light-emitting element 170 flickers at the first flicker frequency and the buzzer sounds at the first sounding frequency and the first volume; when the jack device 100 is in the protected state, the light-emitting element 170 flickers at the second flicker frequency and the buzzer sounds at the second sounding frequency and the second volume.

As shown in FIG. 22, a jack device 100a includes light-emitting elements 170a disposed near traveling wheels 114. When the lifting pad 121 is in a non-lifting state, two traveling wheels 114 closest to the lifting pad 121 are defined as front wheels 1141 of the jack device 100a, and two traveling wheels 114 at the other end and opposite to the front wheels 1141 are defined as rear wheels 1142 of the jack device 100a. The light-emitting elements 170a are disposed above the traveling wheels 114, and light emission surfaces of the light-emitting elements 170a are basically perpendicular to a plane where the multiple traveling wheels 114 can be placed, making it convenient for the user to illuminate dark and narrow spaces such as the bottom of a car. In an example, the light-emitting elements 170a are disposed above the rear wheels 1142. In an example, the light-emitting elements 170a are disposed directly above the rear wheels 1142. The light-emitting elements 170a may be configured to be foldably connected to the housing 113, so as to implement storage in small space and the lighting function.

When the jack device 100 is in the protected state, the indication component is triggered and a power supply circuit of the electric motor 161 is cut off to ensure safety. The jack device 100 includes a current detection module configured to detect the working current of the electric motor 161. When the working current is greater than or equal to a first set current value, the indication component is triggered and the power supply circuit of the electric motor 161 is cut off.

The jack device 100 includes a temperature detection module configured to detect a working temperature of the electric motor 161. When the working temperature is greater than or equal to a first set temperature value, the indication component is triggered and the power supply circuit of the electric motor 161 is cut off. The jack device 100 includes a rotational speed detection module configured to detect a working rotational speed of the electric motor 161. When the working rotational speed is greater than or equal to a first set rotational speed value, the indication component is triggered and the power supply circuit of the electric motor 161 is cut off.

The lifting assembly 120 has the lifting state and the stored state. When the lifting assembly 120 is in the stored state, the lifting assembly 120 is at the storage position. When the lifting assembly 120 is in the lifting state, the lifting assembly 120 may be locked at any position above the storage position.

In the lifting process of the lifting assembly 120, a stroke of the lifting assembly 120 is determined by a stroke sensor. When the jack device 100 rises to approach the end, that is, the lifting limit position, the operation of the electric motor 161 is limited. The lifting speed of the lifting assembly 120 is controlled according to the distance between the lifting pad 121 and the lifted object. The stroke sensor may be a proximity switch, a photoelectric switch, or a Hall switch.

Limiting the operation of the electric motor 161 includes reducing the rotational speed of the electric motor 161 or cutting off the power supply circuit of the electric motor 161. When the distance between the lifting pad 121 and the lifted object is greater than or equal to a first set distance value, the lifting speed of the lifting assembly 120 is increased. When the distance between the lifting pad 121 and the lifted object is less than a second set distance value, the lifting speed of the lifting assembly 120 is reduced. The lifting speed of the lifting assembly 120 may be changed to a constant value each time.

The jack device 100 includes the load detection component configured to detect the load parameter of the lifting assembly 120, and the hydraulic assembly 130 adjusts the lifting or lowering speed of the lifting assembly 120 according to the load parameter. In some examples, the load parameter is the working current of the electric motor 161. When the working current is less than or equal to the first threshold, no load is determined and the lifting speed of the lifting assembly 120 is increased. When the working current is greater than or equal to the second threshold, a relatively large load is determined and the lifting speed of the lifting assembly 120 is reduced.

When the jack device 100 is in the protected state, whether the jack device shuts down for maintenance or continues completing the current operation is comprehensively evaluated according to various parameters.

The jack device 100 includes a power detection module configured to detect the remaining power of the battery pack 200. When the remaining power is less than or equal to a first power value, the jack device 100 switches to a power-saving mode to increase the battery life of the battery pack 200, and the indication component indicates that the power is too low so that the user is reminded to replace the battery pack 200. In the power-saving mode, the electric motor 161 is in a high efficiency interval and has relatively high working efficiency.

The jack device 100 includes the controller. The preceding electronic controls, solenoid valve 190, electric motor 161, detection modules, sensor, and other components that need to be electronically controlled are all electrically connected to the controller. The controller may control the components through programs and circuits. The control principle of the controller belongs to conventional technology and is not repeated here.

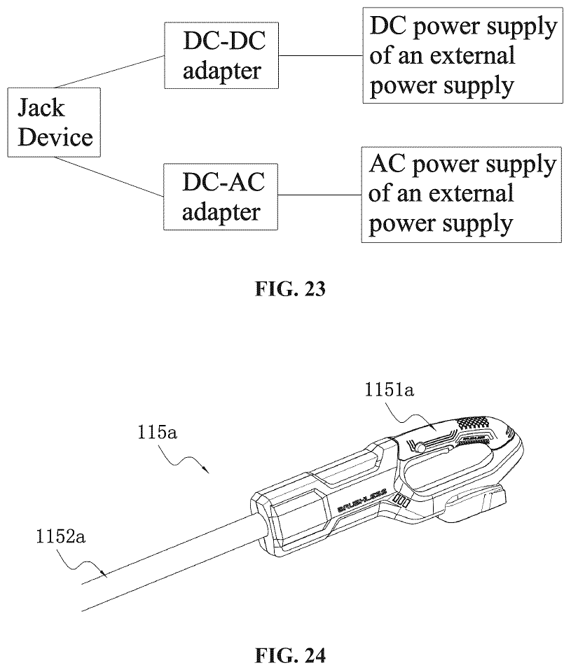

Referring to FIG. 23, in addition to the battery pack 200, the power supply may also be an external power supply. The jack device 100 may be connected to the discharge interface of the external power supply, and the jack device 100 may be powered by the external power supply. In one embodiment, the external power supply may be a vehicle-mounted power supply, and the jack device 100 may be connected to the discharge interface of the vehicle-mounted DC power supply; or, the jack device 100 may be connected to the discharge interface of the vehicle-mounted AC power supply. At present, the discharge voltage of the vehicle-mounted DC power supply is generally 12V, and the discharge voltage of the vehicle-mounted AC power supply is generally 110V or 220V. An adapter may be provided between the external power supply and the jack device 100, and the adapter may be a DC to AC adapter, or a DC to DC adapter, to meet different usage requirements. If the discharge voltage of the vehicle-mounted DC power supply is mates with the jack device 100, no adapter will be needed. Using a vehicle-mounted power supply to supply power can save the electric energy of the battery pack 200 and increase the using conditions of the jack device 100.

To mate with an onboard discharge interface, the jack device 100 is provided with a power interface for connecting the onboard discharge interface, and the onboard discharge interface can receive the onboard DC power supply or the onboard AC power supply. Specifically, the power interface is configured as a circular DC interface with a diameter of 5.5 mm. The power interface may be connected to the discharge interface of the onboard DC power supply through a connecting line, or the power interface may be connected to the discharge interface of the onboard AC power supply through an adapter.

It is to be noted that the solution disclosed in the drawings of the present application is a floor jack device and, in particular, a hydraulic floor jack device and an electric hydraulic floor jack device. A maximum lifting capacity of the jack device 100 is about 2.5 tons. In an example, the maximum lifting capacity of the jack device 100 is about 2 tons. In an example, the maximum lifting capacity of the jack device 100 is about 1.5 tons. In an example, a plunger of the power output end 1321 has a diameter of 6 mm to 10 mm, output torque of the actuator 163 is about 10 N·m, 15 N·m, or 20 N·m, and an eccentricity of the cam 1631 of the actuator 163 is about 4 mm.

The jack device 100 further includes a handle assembly 115 (see FIG. 1) connected to the frame 110, and the handle assembly 115 is rotatable relative to the base 112. The handle assembly 115 includes a handle 1151 and a connecting rod 1152, the handle 1151 is used for the user to hold to drag the jack device 100 to move, and the connecting rod 1152 connects the handle 1151 to the frame 110. A handle switch may be provided on the handle assembly 115. The handle switch is used for the user to operate to control at least one of the start and stop of the electric motor 161, the motion of the lifting assembly 120, and the activation and deactivation of the light-emitting element 170. In an example, the handle switch may be fixed to the handle assembly 115 or is detachably mounted to the handle assembly 115. In an example, the connecting rod 1152 is composed of a telescopic structure so that the user can adjust the distance between the handle 1151 and the base 112 according to needs of the user.

A control panel may also be provided on the handle assembly 115. The control panel may display at least one of an operation state of the electric motor 161, a motion state and a position of the lifting assembly 120, and the state of the light-emitting element 170. In an example, the control panel may be disposed on the housing 113. The handle assembly 115 is arc-shaped, achieving an advantage that the user can hold the handle 1151 at multiple angles and transmit a force smoothly. A handle assembly 115a shown in FIG. 24 is another example of the handle assembly. The handle assembly 115a includes a handle 1151a and a connecting rod 1152a, and the handle 1151a is provided with a grip for the user to hold. The grip of the handle 1151a extends along an extension direction of the connecting rod 1152a, that is to say, a force applied by the user also extends along the extension direction of the connecting rod 1152a so that the handle assembly 115a is easier to manipulate.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A jack device, comprising:
a frame;
a lifting assembly pivotally connected to the frame, wherein one end of the lifting assembly comprises a lifting pad liftable or lowerable, and the lifting pad provides an upward lifting force for a lifted object;
a hydraulic assembly configured to drive the lifting assembly to perform a lifting action or a lowering action;
a power unit comprising an electric motor and an actuator, wherein the actuator is able to drive the hydraulic assembly to operate; and
a battery pack coupling portion for mounting a battery pack, wherein the battery pack supplies power to the power unit.

2. The jack device according to claim 1, wherein the battery pack is detachably connected to the jack device.

3. The jack device according to claim 1, wherein the battery pack is inserted and removed along a direction of a first straight line, and the first straight line basically extends along a front and rear direction.

4. The jack device according to claim 1, wherein the frame comprises a base and a housing, the hydraulic assembly is disposed on the base, and the housing covers the hydraulic assembly.

5. The jack device according to claim 4, wherein the battery pack is mounted in the housing.

6. The jack device according to claim 4, wherein the battery pack partially protrudes out of the housing.

7. The jack device according to claim 1, wherein, when the battery pack is mounted to the battery pack coupling portion, a waterproof cover is provided on an outer side of the battery pack, and the waterproof cover covers at least a top of the battery pack.

8. The jack device according to claim 1, wherein the lifting assembly comprises a lifting arm, the frame comprises a connecting portion, one end of the lifting arm is pivotally connected to the connecting portion, and the battery pack and the lifting pad are distributed on two sides of the connecting portion.

9. The jack device according to claim 1, comprising at least a first operating member configured to control the hydraulic assembly to drive an action of the lifting assembly.

10. The jack device according to claim 9, wherein the first operating member is electronically controlled.

11. The jack device according to claim 1, comprising a load detection component configured to detect a load parameter of the lifting assembly, wherein the hydraulic assembly adjusts a lifting or lowering speed of the lifting assembly according to the load parameter.

12. The jack device according to claim 1, comprising at least a second operating member configured to control the hydraulic assembly to relieve pressure.

13. The jack device according to claim 1, comprising a lowering operating member configured to, in a triggered state, control the hydraulic assembly to relieve pressure, wherein, when the lowering operating member is triggered, the lifting pad automatically descends in height.

14. The jack device according to claim 13, wherein the hydraulic assembly comprises a solenoid valve configured to open or close a pressure relief oil loop of the hydraulic assembly, and the solenoid valve is in an energized state when the lowering operating member is in the triggered state.

15. The jack device according to claim 1, wherein the hydraulic assembly comprises a hydraulic pump and a hydraulic cylinder, the actuator drives the hydraulic pump to operate, the battery pack is configured to supply power to the electric motor, a motor shaft of the electric motor extends along a direction of a second straight line, the hydraulic cylinder acts along a direction of a third straight line, and the second straight line is parallel or perpendicular to the third straight line.

16. The jack device according to claim 1, further comprising a light-emitting element disposed on the frame and configured to indicate a working state of the jack device.

17. The jack device according to claim 1, further comprising a light-emitting element able to turn on or off and configured to indicate a working state of the jack device.

18. The jack device according to claim 1, further comprising a light-emitting element able to be ejected or hidden and configured to indicate a working state of the jack device.

19. The jack device according to claim 1, wherein the jack device is provided with a power interface for connecting an onboard discharge interface, and the onboard discharge interface is able to receive an onboard direct current (DC) power supply or an onboard alternating current (AC) power supply.

20. The jack device according to claim 1, further comprising light-emitting elements for lighting and traveling wheels, wherein the traveling wheels comprise front wheels and rear wheels, the front wheels are disposed on a side closer to the lifting pad, the rear wheels are disposed on another side opposite to the front wheels, and the light-emitting elements are disposed above the rear wheels.
